(19) United States
(12) Patent Application Publication
(10) Pub. No.: US 2021/0117939 A1
(43) Pub. Date: Apr. 22, 2021

(54) SYSTEM AND METHOD FOR MONITORING FACILITIES AVAILABLE FOR PUBLIC USE

(71) Applicants: Amol Vitthal Bhinge, (US); PALSAK Inc., Austin, TX (US)

(72) Inventor: Amol Vitthal BHINGE, Austin, TX (US)

(21) Appl. No.: 16/657,002

(22) Filed: Oct. 18, 2019

(51) Int. Cl. G06Q 20/08; G06Q 20/32; G06Q 30/02; G06Q 10/02

(52) U.S. Cl. CPC G06Q 20/0855; G06Q 20/325; G06Q 10/02; G06Q 30/0201; G06Q 30/0282

(57) ABSTRACT

A system, method and computer-readable medium storing instruction for monitoring a facility are disclosed. The system for monitoring a facility, having a server and a communication device including a user interface, wherein the server further comprises a processor in communication with a memory and at least one database, and wherein the server is configured to: register at least one first user by receiving registration information for the at least one first user; register one or more facilities by receiving registration information for the one or more facilities, wherein registration information for the one or more facilities includes any one or more of: location of the facility, ownership of the facility, services available of the facility; and receive facility information from the at least one first user including any one or more of: availability information for the facility, maintenance schedule of the facility, current maintenance status of the facility.

### CROSS-REFERENCE TO RELATED APPLICATION

This application is related to U.S. patent application Ser. No. ______ (Docket No. 4710.1018BS), filed on Oct. ______, 2019, entitled “SYSTEM AND METHOD FOR LOCATING FACILITIES AVAILABLE FOR PUBLIC USE” all of which is incorporated herein by reference in its entirety.

### TECHNICAL FIELD

The embodiments described herein pertain generally to providing a system and method for locating facilities available for public use.

### BACKGROUND

Finding clean washrooms can be a difficult task in many countries. This gives rise to a need for washroom services, paid or unpaid, that are maintained and monitored to provide for people's needs.

### SUMMARY

In one example embodiment, a system for locating facilities available for use includes a communication device including a user interface and a server, wherein the server further includes a processor in communication with a memory and at least one database. The server is configured to compile information regarding one or more facilities, and register at least one client by receiving registration information for the at least one client; store the information for the one or more facilities and the at least one client to the at least one database; receive a search request for finding a facility from the at least one client; match the search request received from the at least one client with at least one of the one or more facilities that is registered based on at least one criterion included in the search request; and provide results of the matching to the at least one client via the user interface.

In another example embodiment, a computer-implemented method for locating facilities available for use includes compiling information regarding one or more facilities; registering at least one client by receiving registration information for the at least one client; storing the information for the one or more facilities and the at least one client to the at least one database; receiving a search request for finding a facility from the at least one client; matching the search request received from the at least one client with at least one of the one or more facilities that is registered based on at least one criterion included in the search request; and providing results of the matching to the at least one client.

In yet another example embodiment, a computer-readable medium for locating facilities available for use stores instructions that, when executed, cause one or more processors corresponding to a system having a server and a communication device, to perform operations comprising: compiling information regarding one or more facilities; registering at least one client by receiving registration information for the at least one client; storing the information for the one or more facilities and the at least one client; receiving a search request for finding a facility from the at least one client; matching the search request received from the at least one client with at least one of the one or more facilities that is registered based on at least one criterion included in the search request; and providing results of the matching to the at least one client.

In an example embodiment, a system for monitoring a facility, comprising a server and a communication device including a user interface, wherein the server further includes a processor in communication with a memory and at least one database, and wherein the server is configured to: register at least one user by receiving registration information for the at least one user; register one or more facilities by receiving registration information for the one or more facilities, wherein registration information for the one or more facilities comprises any one or more of: location of the facility, ownership of the facility, services available of the facility; and receive facility information from the at least one user including any one or more of: availability information for the facility, maintenance schedule of the facility, current maintenance status of the facility.

In another example embodiment, a computer-implemented method for monitoring a facility includes: registering at least one first user by receiving registration information for the at least one first user; registering one or more facilities by receiving registration information for the one or more facilities, wherein registration information for the one or more facilities includes any one or more of: location of the facility, ownership of the facility, services available of the facility; and receiving facility information from the at least one first user including any one or more of: availability information for the facility, maintenance schedule of the facility, current maintenance status of the facility.

In yet another example embodiment, non-transitory computer-readable medium storing instructions that, when executed, cause one or more processors corresponding to a system for monitoring a facility having a server and a communication device, to perform operations including: registering at least one first user by receiving registration information for the at least one first user; registering one or more facilities by receiving registration information for the one or more facilities, wherein registration information for the one or more facilities includes any one or more of: location of the facility, ownership of the facility, services available of the facility; and receiving facility information from the at least one first user including any one or more of: availability information for the facility, maintenance schedule of the facility, current maintenance status of the facility.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration 100 in one or more embodiments for locating facilities available for use may be implemented according to one or more embodiments described herein.

FIGS. 2A-C show example processing flow of operations 200 for locating facilities available for use according to one or more embodiments described herein.

FIG. 3 shows an example processing flow of operations 300 for locating facilities available for use according to one or more embodiments described herein.

FIG. 4 shows an example system configuration 400 in one or more embodiments for locating facilities available for use and monitoring a facility may be implemented according to one or more embodiments described herein.

FIG. 5A shows an example processing flow of operations 500 for updating information of the facilities available for use according to one or more embodiments described herein.

FIG. 5B shows an example processing flow of operations 500′ for monitoring a facility according to one or more embodiments described herein.

FIG. 6 shows an example computing device 600 by which various embodiments of the method for locating facilities available for use described herein may be implemented.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Finding clean washrooms can be a difficult task in many countries. This gives rise to a need for washroom services, paid or unpaid, that are maintained and monitored to provide for people's needs. Although, locating washrooms for public use is described herein as an example, the invention may be applicable to other facilities, for example, mother's room for nursing mothers or a professionally maintained place available for public usage such as a hotel room, a restaurant, a bathroom, a shower, a trash bin, etc.

Described herein are embodiments of the system, method and computer-readable medium storing instruction for locating facilities available for use.

In one example embodiment, the system for locating facilities available for use includes a communication device including a user interface and a server, wherein the server further includes a processor in communication with a memory and at least one database. The server is configured to compile information regarding one or more facilities, and register at least one client by receiving registration information for the at least one client; store the information for the one or more facilities and the at least one client to the at least one database; receive a search request for finding a facility from the at least one client; match the search request received from the at least one client with at least one of the one or more facilities that is registered based on at least one criterion included in the search request; and provide results of the matching to the at least one client via the user interface.

In another example embodiment, the computer-implemented method for locating facilities available for use includes compiling information regarding one or more facilities; registering at least one client by receiving registration information for the at least one client; storing the information for the one or more facilities and the at least one client to the at least one database; receiving a search request for finding a facility from the at least one client; matching the search request received from the at least one client with at least one of the one or more facilities that is registered based on at least one criterion included in the search request; and providing results of the matching to the at least one client.

In yet another example embodiment, the computer-readable medium for locating facilities available for use stores instructions that, when executed, cause one or more processors corresponding to a system having a server and a communication device, to perform operations comprising: compiling information regarding one or more facilities; registering at least one client by receiving registration information for the at least one client; storing the information for the one or more facilities and the at least one client; receiving a search request for finding a facility from the at least one client; matching the search request received from the at least one client with at least one of the one or more facilities that is registered based on at least one criterion included in the search request; and providing results of the matching to the at least one client.

In an example embodiment, a system for monitoring a facility, comprising a server and a communication device including a user interface, wherein the server further comprises a processor in communication with a memory and at least one database, and wherein the server is configured to: register at least one user by receiving registration information for the at least one user; register one or more facilities by receiving registration information for the one or more facilities, wherein registration information for the one or more facilities includes any one or more of: location of the facility, ownership of the facility, services available at the facility; and receive facility information from the at least one user including any one or more of: availability information for the facility, maintenance schedule of the facility, current maintenance status of the facility.

In another example embodiment, a computer-implemented method for monitoring a facility includes: registering at least one user by receiving registration information for the at least one user; registering one or more facilities by receiving registration information for the one or more facilities, wherein registration information for the one or more facilities includes any one or more of: location of the facility, ownership of the facility, services available at the facility; and receiving facility information from the at least one user including any one or more of: availability information for the facility, maintenance schedule of the facility, current maintenance status of the facility.

In yet another example embodiment, non-transitory computer-readable medium storing instructions that, when executed, cause one or more processors corresponding to a system for monitoring a facility having a server and a communication device, to perform operations including: registering at least one user by receiving registration information for the at least one user; registering one or more facilities by receiving registration information for the one or more facilities, wherein registration information for the one or more facilities includes any one or more of: location of the facility, ownership of the facility, services available at the facility; and receiving facility information from the at least one user including any one or more of: availability information for the facility, maintenance schedule of the facility, current maintenance status of the facility.

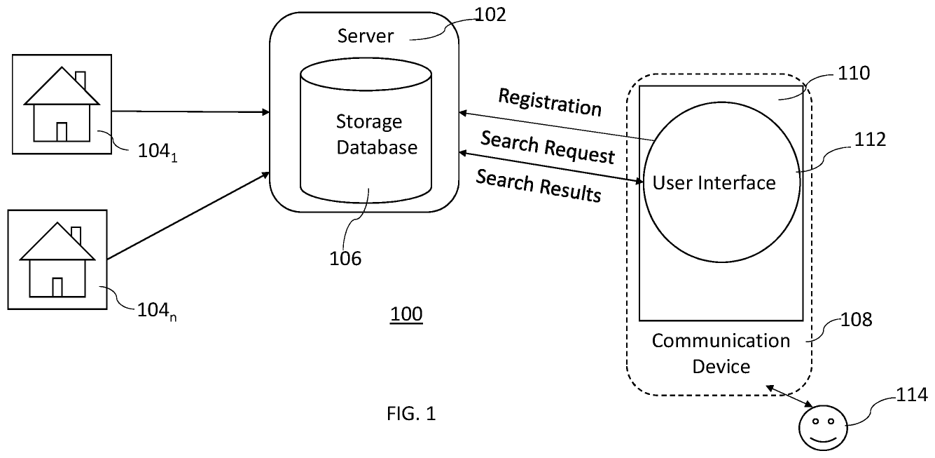

FIG. 1 shows in one or more embodiments of a system for locating facilities 104₁ . . . 104ₙ available for use may be implemented. As depicted, configuration 100 also known as a platform for locating facilities available for use and includes, at least, a server 102, a storage database 106, an instance of a client application 110 hosted on a communication device 108 corresponding to a client 114 and a user interface 112. Alternatively, the application may be hosted on the server 102.

Communication device or a client device 108 may refer to smartphone, tablet, PC, or other processor-driven computing device.

The method and system may be provided as an application which may be a web-based application and/or a mobile application and allow users to search/view facilities available for use using different criteria using interactive user interface 112.

Platform provider may refer to an entity providing an application for connecting a facility, for example, any one or more of facilities 104₁ . . . 104ₙ, with the client 114 and the platform may refer to the application 110 for providing information regarding a facility, for example, any one or more of facilities 104₁ . . . 104ₙ, to the client 114.

As depicted in FIG. 1, the system 100 may include a server 102, configured to compile information regarding one or more facilities 104₁ . . . 104ₙ, and register at least one client 114 by receiving registration information for the at least one client 114; store the information for the one or more facilities 104₁ . . . 104ₙ and the at least one client 114 to the at least one database 106. The facility for use may include any one or more of: a washroom, a restroom, a toilet, a mother's room, and a professionally maintained place for public usage, such as a hotel room, a restaurant, a bathroom, a shower, a toilet, a trash bin, or a combination thereof.

Server 102 may be further configured to register a client 114 via client device 108 by providing registration information for the client 114. The registration information for registering the client 114 may include any one or more of: contact information of the client 114, mode of payment, payment account information, location of the client 114, relationship of the client requesting registration 114 with the other registered clients.

Location of the client 114 may be provided by the client 114 themselves or may be tracked using commercially available location detection service on the client's communication device 108.

Mode of payment may include any one or more of: credit card, bank transfer, cash, a combination thereof etc. and payment account information may include any of credit card or debit card information, bank account information etc. that may be used to carry out the transaction. In an embodiment, this information may be optional.

In an embodiment, the server 102 may be provided with one or more storage databases 106 to store the compiled information regarding one or more facilities 104₁ . . . 104ₙ and the client 114. The system 100 may include separate storage databases to store information regarding one or more facilities 104₁ . . . 104ₙ and client 114. Alternatively, the system 100 may include a single storage database to store registration information regarding one or more facilities 104₁ . . . 104ₙ and the client 114. The storage databases 106 may be local to the server or may be remote.

Information regarding facilities available for public use, may be compiled and published as a static database. The static database may use existing commercially available maps showing businesses/other locations and update the maps with the facility information. The static database may be updated at regular intervals or based on number of new datapoints.

The facilities included in the database may be speculative and/or non-speculative. Speculative facilities, e.g., public toilets, may be complimentary facilities offered by the businesses for their customers, not just free facilities. The speculation may be based on one or more attributes comprising: type of business, e.g., a coffee shop, a restaurant or a gas station; name of the business, e.g., Starbucks™/Pizza Hut™, that is speculated to have a facility such as a toilet on their premises. Users/reviewers/entities may confirm the existence of such speculative toilets. Similarly, business owners may claim speculative toilets as one offered to their customers/non-customers by their business providing confirmation of existence of a facility, e.g., a toilet, offered by that business. Non-speculative facilities, e.g., public toilets, may be based on user input, where the users are aware of the existence of a facility from their experience and provide data to the app via user interface 112.

Once registered with the platform/application provider, client 114 may enter a search request to locate a facility for use. The search request may be entered via user interface 112 on the client device 108, and the server 102 may be configured to receive this request.

The search request to locate a facility may include providing any one or more of: location of the facility, location of the client, time of use. The application may allow the client to enter criteria or filters used for the search via interactive user interface 112 or to select them from a drop-down list provided on the user interface 112.

Additionally or alternatively, a minimum criteria or primary criteria for matching the search request may be specified beforehand, e.g. at the time of registration or any time before the search is requested or at the time when the search is requested by the client. A matching facility may be chosen based on these predetermined criteria. The predetermined criteria may include any of: distance between the facility and the client, location of the facility, location of the client, hours of operation of the facility, basic or mandatory service that a facility must offer to be included in the search result or a combination thereof.

In an embodiment, the application may allow users to enter additional search criteria or sorting criteria via interactive user interface 112 or to select it from a drop-down list. The additional search criteria or sorting criteria may include any one or more of: selection of services, type of business offering the facility, cleaning schedule of the facility, current cleaning status of the facility, status of the facility as a claimed facility or unclaimed facility, certified facility, verified facility, maintenance information of the facility and type of facility such as free of charge, complementary or pay per use facility, reviews of the facility, date of review of the facility, rating of the facility, rating of the facility by the clients belonging to a network based on the relationship of the client requesting search with the other registered clients.

Upon receiving the search request, the server 102 uses an algorithm to identify one or more facilities that match the primary criteria such as location of the facility and time of use. The server 102 then publishes the search results via user interface 112 providing information regarding the facility based on a sorting methodology. The sorting methodology may be a default methodology or the one selected by the client.

A list of available facilities may appear as a result of the search, with more information regarding other parameters listed as facility information including any one or more of: selection of services, type of business offering the facility, cleaning schedule of the facility, current cleaning status of the facility, status of the facility as claimed facility or unclaimed facility, certified facility, verified facility, maintenance information of the facility and type of facility such as free of charge, complementary or pay per use facility, reviews of the facility, date of review of the facility, rating of the facility, rating of the facility by the clients belonging to a network based on the relationship of the client requesting search with the other registered clients.

Location of the facilities 104₁ . . . 104ₙ may be provided by the facility provider, by the clients themselves as they find new facilities for use or may be tracked using commercially available location detection service or mapping products. For example, location of a coffee shop, a restaurant or a gas station that is speculated to have a facility such as a toilet on their premises may be extracted using commercial mapping products.

Availability of the facilities 104₁ . . . 104ₙ may be provided as currently available/not available, or as hours of operation and may further include preferred days of the week, days of the month or time of the day, or the date/day and time the facility is available for use. This information may be provided by the facility providers, by the clients, or may be extracted by the server based on the type of business and/or provided by the business owners and/or users of the application.

Services offered by the facilities 104₁ . . . 104ₙ may be categorized as services that must be offered by the facilities 104₁ . . . 104ₙ to be classified as a facility and optional services that the facilities 104₁ . . . 104ₙ may offer based on their ability and availability. For example, a facility such as a restroom or a toilet must offer a restroom or a toilet to be classified as a facility, additionally, if the facility is located at a business such as a coffee shop, a restaurant or a mall, it may offer other optional services such as food, drink, changing rooms etc. depending on the type of business. This information may be extracted based on the type of business and/or provided by the business owners and/or users of the application.

Contact information for the facility may include phone number, email address etc.

Type of business offering the facility, for example, a coffee shop, a restaurant, a mall, a gas station or a petrol pump, movie theater, grocery store etc. Business owners may claim speculative toilets as one offered to their customers/non-customers by their business providing confirmation of existence of a facility, e.g., a toilet, offered by that business providing status of the facility as claimed facility or unclaimed facility.

Additionally or alternatively, the method and system may allow for tracking cleaning schedule of the facility. For example, for a facility such as a toilet, last cleaning time of the toilet, current status on cleanliness etc., by enabling the facility owners to log such information and by allowing users to access this information in real time or near real time thereby providing recent status on cleanliness/maintenance of the facility as cleaning schedule/status.

In an embodiment, the method and system may allow users to view “certified” or “verified” facilities. In case of verified facility, existence of the facility may be verified either by the facility provider as a claimed facility, by the client as an existing facility or by a third party as an existing facility. In case of certified facility, a facility may be certified by an entity, for example, the platform/application provider and/or a third-party responsible for providing such certification, regarding cleanliness of the facility, maintenance schedule, availability of the services at the facility, etc.

Additionally, or alternatively, the method and system may allow users, e.g., clients, facility providers or third parties responsible for maintenance and/or certification of the facility, to view maintenance information of the facility, e.g., “maintained” toilets which may be toilets maintained by “third party” that ensures cleanliness, amenities etc. for a toilet. Maintenance information of the facility may include information such as, for example, the information logged in may include last cleaned, soap refilled, toilet paper refilled etc. for toilets.

The method and system may also allow users to view type of facility such as free of charge facility, complementary facility offered by businesses for their customers, and/or pay per use facility. In an embodiment, the method and system may allow entities, e.g., homeowners, business owners etc. to offer/list toilets on their premises for a charge, e.g., pay per use facility.

The method and system may also provide other information about the facility, e.g., for toilets the information may include type of toilet such as Asian squatting toilet, western sitting toilet, men's toilet, urinals only, women's toilet, a moving or portable toilet etc. Additional other information such as existence of electric lights, wash basin, toilet papers, paper napkins/dryer, soap/sanitizer, water supply, trash bins etc. may also be provided.

Reviews of the facility may include information such a cleanliness, maintenance availability of services, quality of services, date of review of the facility, etc. The reviews may be provided by clients or a third party such as entities responsible for certifying the facility. The client may be provided a questionnaire to answer using user interface 112 on the client device 108, the answers to which may be published as client review. Client review may also be used to calculate rating for each facility.

Rating of the facility may include information including rating in absolute number, e.g., on a scale of 1 to 5, or on a scale of 1 to 10 etc. and may be provided as overall rating, current year's rating, previous years' rating, current month's rating, previous months' rating, current week's rating, today's rating, any specific year/month/week/day rating etc. The client may be provided with a questionnaire to answer questions using user interface 112 on the client device 108, and the answers to the questionnaire may be used to calculate cumulative ratings in different formats discussed above. Different forms of ratings described herein, e.g., current year's rating, previous years' rating, current month's rating, previous months' rating, current week's rating, today's rating, any specific year/month/week/day rating etc., may be calculated and/or sorted based on the date of review.

In an embodiment, the information regarding a facility such as ownership of the facility, name of the facility may change over time which then may be reflected in reviews and ratings when sorted and provided as search results. For example, restaurants may go through ownership (management) change with same or different name and thus, ratings from the past do not hold much relevance to today's situation and hence the method and system described herein may sort the ratings and reviews of the restaurant that has undergone such changes based on name of the facility, change of ownership etc. as separate facilities rather than presenting them as a single facility.

Additionally, or alternatively rating of the facility may specifically include ratings based on reviews by clients/users from that user's/client's network created by the users/clients by selecting and adding other clients/users registered with the application/platform. User's/client's network may also be created by the platform based on the information provided by clients/users regarding their relationship with other registered clients/users during registration process. Thus, the method and system allow users to create their own network of people, for example, family, friends, and choose to view results, e.g., availability, ratings, reviews etc. from the network of their choice. Relationship information may include relationships such as but not limited to friend, family, colleague etc.

Additionally, or alternatively, the method and system may allow users to view results, e.g., availability/hours of operation, ratings, reviews etc. from their network's network, e.g., any number of chosen levels where the user level may be designated as level 0 to direct connections designated as network level 1, secondary connections designated as network level 2 and so on to network level N.

In an embodiment, the ratings, reviews and sorting mechanism used for the reviews and ratings discussed above are also applicable to other reviews and ratings such as quality of food, quality of service for restaurants, other services etc. Similarly, in an embodiment, the ratings and reviews based on reviews by clients/users from that user's/client's network created by the users/clients by selecting and adding other clients/users registered with the application/platform are also applicable to reviews and ratings for parameters such as quality of food, quality of service for restaurants, other services etc.

In an embodiment, the method and system may include receiving specific instructions/feedback/issues from customer/user that is communicated to maintenance owner/cleaning staff. The feedback may include instructions or issues such as but not limited to reporting quality of facility, amenities missing from the facility, and/or any issues with the facility. For example, if something is not working in a hotel room, customers/users can report the issue to the facility provider and/or third party such as an entity responsible for maintaining the facility, maintenance staff etc.

In an embodiment, the method and system allow processing payments from the at least one client/user of the facility. The payments may include any one or more of: charge for the usage of the facility, tips or gratuity to the entity responsible for providing the facility and tips or gratuity to maintenance staff responsible for maintaining the facility.

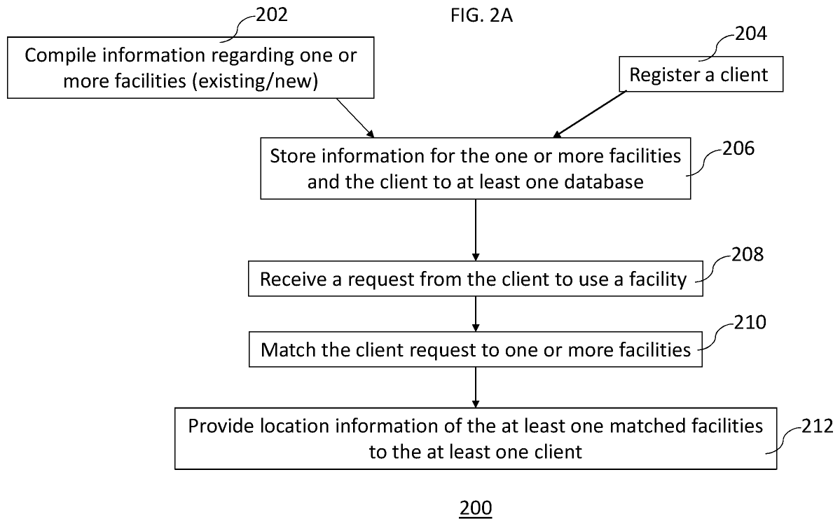

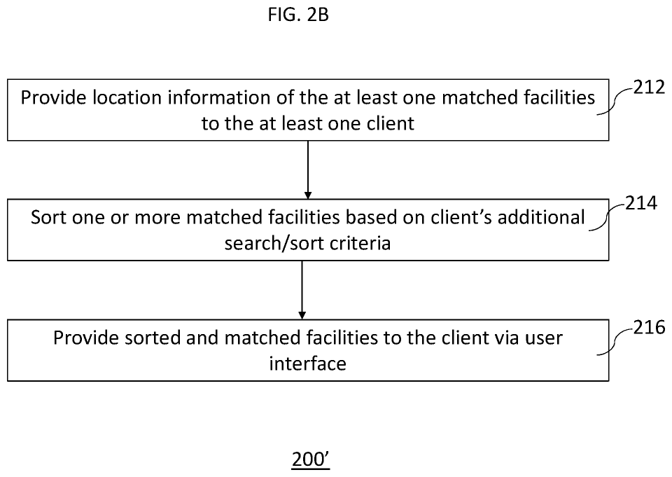

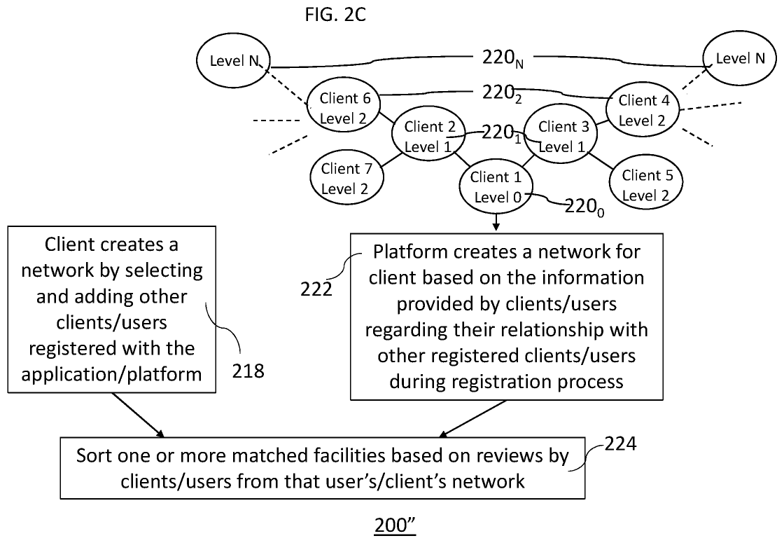

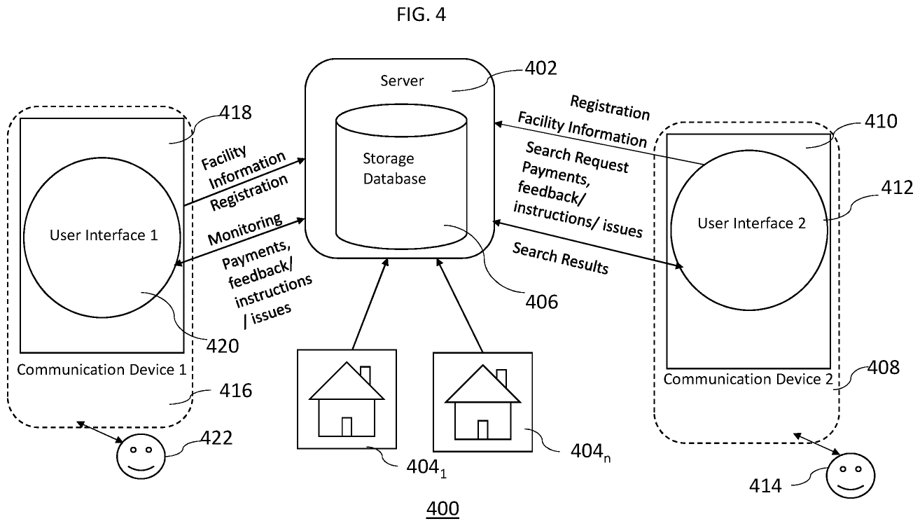

FIGS. 2A, 2B and 2C show example processing flow of operations 200, 200′ and 200″ for implementing at least portions of a method for locating facilities available for use. The method described here may be implemented using the system described in detail in FIG. 1 and the description accompanying FIG. 1 including at least, an instance of a client application hosted on a communication device corresponding to one or more user equipment and a user interface. Additionally or alternatively, the method described here may be implemented using system 400 as illustrated in FIG. 4 and is described in detail in the description accompanying FIG. 4.

As shown in FIG. 2A, the computer-implemented method 200 includes compiling information regarding one or more facilities via step 202; registering at least one client by receiving registration information for the at least one client via step 204; storing the information for the one or more facilities and the at least one client to the at least one database via step 206; receiving a search request for finding a facility from the at least one client via step 208; matching the search request received from the at least one client with at least one of the one or more facilities that is registered based on at least one criterion included in the search request via step 210; and providing results of the matching to the at least one client via step 212.

The facility for use may include any one or more of: a washroom, a restroom, a toilet, a mother's room, and a professionally maintained place for public usage such as a hotel room, a restaurant, a bathroom, a toilet, a shower and a trash bin or a combination thereof.

The method further includes registering a client via client device by receiving registration information for the client. The registration information for registering the client may include any one or more of: contact information of the client, mode of payment, payment account information, location of the client, relationship of the client requesting registration with the other registered clients.

Location of the client may be provided by the client themselves or may be tracked using commercially available location detection service on the client's communication device.

Mode of payment may include any one or more of: credit card, bank transfer, cash, a combination thereof etc. and payment account information may include any of credit card or debit card information, bank account information etc. that may be used to carry out the transaction. In an embodiment, this information may be optional.

The computer-implemented method further includes storing the compiled information regarding one or more facilities and the client. The information regarding one or more facilities and client may be stored in the same storage database or separate storage databases, which may be local to the server or may be remote.

Information regarding facilities available for public use, may be compiled and published as a static database. The static database may use existing commercially available maps showing businesses/other locations and update the maps with the facility information. The static database may be updated at regular intervals or based on number of new datapoints.

The facilities included in the database may be speculative and/or non-speculative. Speculative facilities, e.g., public toilets, may be complimentary facilities offered by the businesses for their customers, not just free facilities. The speculation may be based on one or more attributes comprising: type of business, e.g., a coffee shop, a restaurant or a gas station; name of the business, e.g., Starbucks™/Pizza Hut™, that is speculated to have a facility such as a toilet on their premises. Users/reviewers/entities may confirm the existence of such speculative toilets. Similarly, business owners may claim speculative toilets as one offered to their customers/non-customers by their business providing confirmation of existence of a facility, e.g., a toilet, offered by that business. Non-speculative facilities, e.g., public toilets, may be based on user input, where the users are aware of the existence of a facility from their experience and provide data to the app via user interface.

Once registered with the platform/application provider, the method allows the client to enter a search request to locate a facility for use. The search request may be entered via user interface on the client device. The search request to locate a facility may include providing any one or more of: location of the facility, location of the client, time of use etc. The method may allow the client to enter the criteria or filters to be used for the search via interactive user interface or to select the search criteria or filters to be used for the search from a drop-down list.

Additionally or alternatively, the minimum or primary criteria for matching the search request may be specified beforehand, e.g., at the time of registration or any time before the search is requested or at the time when the search is requested by the client. The matching facility may be chosen based on this predetermined criteria. The predetermined criteria may include any one or more of: distance between the facility and the client, location of the facility, location of the client, hours of operation of the facility, basic or mandatory service that a facility must offer to be included in the search result.

In an embodiment, the method may allow users to enter additional search criteria or sorting criteria using interactive user interface or to select additional search criteria or sorting criteria from a drop-down list via step 214 as illustrated in FIG. 2B. The additional search criteria or sorting criteria may include any one or more of: selection of services, type of business offering the facility, cleaning schedule of the facility, current cleaning status of the facility, status of the facility as a claimed facility or unclaimed facility, certified facility, verified facility, maintenance information of the facility and type of facility such as free of charge, complementary or pay per use facility, reviews of the facility, date of review of the facility, rating of the facility, rating of the facility by the clients belonging to a network based on the relationship of the client requesting search with the other registered clients.

Upon receiving the search request, the server uses an algorithm to identify facilities that match the primary criteria such as location of the facility and time of use. The server then publishes the search results via user interface providing information regarding the facility based on a sorting methodology via step 216 as illustrated in FIG. 2B. The sorting methodology may be a default methodology or the one selected by the client.

A list of available facilities may appear as a result of the search, with more information regarding other parameters listed as facility information, e.g., type of business offering the facility, cleaning schedule of the facility, current cleaning status of the facility, status of the facility as claimed facility or unclaimed facility, certified facility, verified facility, maintenance information of the facility and type of facility such as free of charge, complementary or pay per use facility, reviews of the facility, date of review of the facility, rating of the facility, rating of the facility by the clients belonging to a network based on the relationship of the client requesting search with the other registered clients.

Location of the facilities may be provided by the facility provider, by the clients themselves as they find new facilities for use or may be tracked using commercially available location detection service or mapping products. For example, location of a coffee shop, a restaurant or a gas station that is speculated to have a facility such as a toilet on their premises may be extracted using commercial mapping products.

Availability of the facilities may be provided as currently available/not available, or as hours of operation and may further include preferred days of the week, days of the month or time of the day, or the date/day and time the facility is available for use. This information may be provided by the facility providers, by the clients, or may be extracted by the server based on the type of business and/or provided by the business owners and/or users of the application.

Services offered by the facilities may be categorized as services that must be offered by the facilities to be classified as a facility and optional services that the facilities may offer based on their ability and availability. For example, a facility such as a restroom or a toilet must offer a restroom or a toilet to be classified as a facility, additionally, if the facility is located at a business such as a coffee shop, a restaurant or a mall, it may offer other optional services such as food, drink, changing rooms etc. depending on the type of business. This information may be extracted based on the type of business and/or provided by the business owners and/or users of the application.

Contact information for the facility may include phone number, email address etc.

Type of business offering the facility, for example, a coffee shop, a restaurant, a mall, a gas station or a petrol pump, movie theater, grocery store etc. Business owners may claim speculative toilets as one offered to their customers/non-customers by their business providing confirmation of existence of a facility, e.g., a toilet, offered by that business providing status of the facility as claimed facility or unclaimed facility.

Additionally or alternatively, the method and system may allow for tracking cleaning schedule of the facility. For example, for a facility such as a toilet, last cleaning time of the toilet, current status on cleanliness etc., by enabling the facility owners to log such information and by allowing users to access this information in real time or near real time thereby providing recent status on cleanliness/maintenance of the facility as cleaning schedule/status.

In an embodiment, the method and system may allow users to view “certified” or “verified” facilities. In case of verified facility, existence of the facility may be verified either by the facility provider as a claimed facility, by the client as an existing facility or by a third party as an existing facility. In case of certified facility, a facility may be certified by an entity, for example, the platform/application provider and/or a third-party responsible for providing such certification, regarding cleanliness of the facility, maintenance schedule, availability of the services at the facility, etc.

Additionally, or alternatively, the method and system may allow users, e.g., clients, facility providers or third parties responsible for maintenance and/or certification of the facility, to view maintenance information of the facility, e.g., “maintained” toilets which may be toilets maintained by “third party” that ensures cleanliness, amenities etc. for a toilet. Maintenance information of the facility may include information such as, for example, the information logged in may include last cleaned, soap refilled, toilet paper refilled etc. for toilets.

The method and system may also allow users to view type of facility such as free of charge facility, complementary facility offered by businesses for their customers, and/or pay per use facility. In an embodiment, the method and system may allow entities, e.g., homeowners, business owners etc. to offer/list toilets on their premises for a charge, e.g., pay per use facility.

The method and system may also provide other information about the facility, e.g., for toilets the information may include type of toilet such as Asian squatting toilet, western sitting toilet, men's toilet, urinals only, women's toilet, a moving or portable toilet etc. Additional other information such as existence of electric lights, wash basin, toilet papers, paper napkins/dryer, soap/sanitizer, water supply, trash bins etc. may also be provided.

Reviews of the facility may include information such a cleanliness, maintenance availability of services, quality of services, date of review of the facility, etc. The reviews may be provided by clients or a third party such as entities responsible for certifying the facility. The client may be provided a questionnaire to answer using user interface on the client device, the answers to which may be published as client review. Client review may also be used to calculate rating for each facility.

Rating of the facility may include information including rating in absolute number, e.g., on a scale of 1 to 5, or on a scale of 1 to 10 etc. and may be provided as overall rating, current year's rating, previous years' rating, current month's rating, previous months' rating, current week's rating, today's rating, any specific year/month/week/day rating etc. The client may be provided with a questionnaire to answer questions using user interface on the client device, and the answers to the questionnaire may be used to calculate cumulative ratings in different formats discussed above. Different forms of ratings described herein, e.g., current year's rating, previous years' rating, current month's rating, previous months' rating, current week's rating, today's rating, any specific year/month/week/day rating etc., may be calculated and/or sorted based on the date of review.

In an embodiment, the information regarding a facility such as ownership of the facility, name of the facility may change over time which then may be reflected in reviews and ratings when sorted and provided as search results. For example, restaurants may go through ownership (management) change with same or different name and thus, ratings from the past do not hold much relevance to today's situation and hence the method and system described herein may sort the ratings and reviews of the restaurant that has undergone such changes based on name of the facility, change of ownership etc. as separate facilities rather than presenting them as a single facility.

Additionally, or alternatively rating of the facility may specifically include ratings based on reviews by clients/users from that user's/client's network created by the users/clients by selecting and adding other clients/users registered with the application/platform via step 218 as illustrated in FIG. 2C. User's/client's network may also be created by the platform based on the information provided by clients/users regarding their relationship with other registered clients/users during registration process via step 222 as illustrated in FIG. 2C. Thus, the method and system allow users to create their own network of people, for example, family, friends, and choose to view results, e.g., availability, ratings, reviews etc. from the network of their choice. Relationship information may include relationships such as but not limited to friend, family, colleague etc.

Additionally, or alternatively, the method and system may allow users to view results, e.g., availability/hours of operation, ratings, reviews etc. from their network's network, e.g., any number of chosen levels where the user level 220₀ may be designated as level 0 to direct connections 220₁ designated as network level 1, secondary connections 220₂ designated as network level 2 and so on to network level N, e.g. 220_{N} as illustrated in FIG. 2C.

In an embodiment, the ratings, reviews and sorting mechanism used for the reviews and ratings discussed above are also applicable to other reviews and ratings such as quality of food, quality of service for restaurants, other services etc. Similarly, in an embodiment, the ratings and reviews based on reviews by clients/users from that user's/client's network created by the users/clients by selecting and adding other clients/users registered with the application/platform are also applicable to reviews and ratings for parameters such as quality of food, quality of service for restaurants, other services etc.

In an embodiment, the method and system may include receiving specific instructions/feedback/issues from customer/user that is communicated to maintenance owner/cleaning staff. The feedback may include instructions or issues such as but not limited to reporting quality of facility, amenities missing from the facility, and/or any issues with the facility. For example, if something is not working in a hotel room, customers/users can report the issue to the facility provider and/or third party such as an entity responsible for maintaining the facility, maintenance staff etc.

In an embodiment, the method and system allow processing payments from the at least one client/user of the facility. The payments may include any one or more of: charge for the usage of the facility, tips or gratuity to the entity responsible for providing the facility and tips or gratuity to maintenance staff responsible for maintaining the facility.

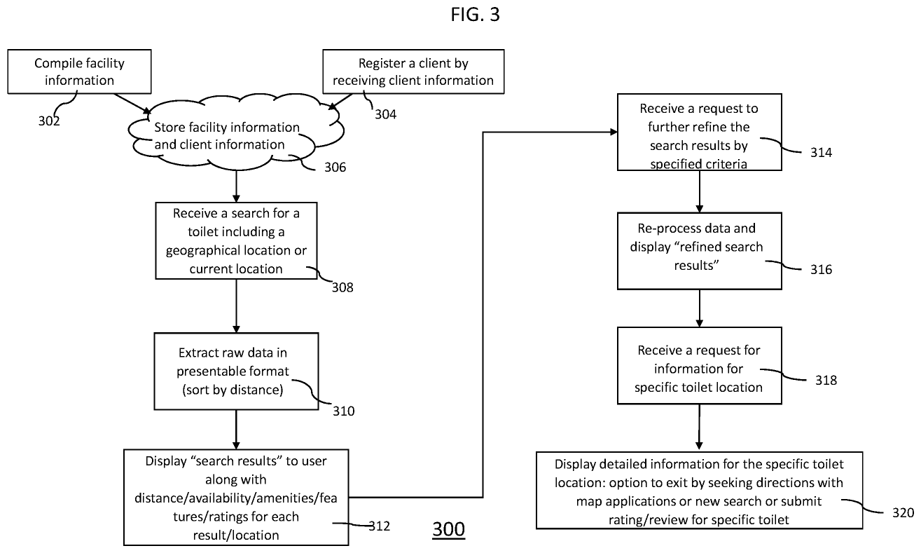

FIG. 3 illustrates an example processing flow of operations for implementing at least portions of a method for locating facilities available for use according to an embodiment described herein. The exemplary embodiment described herein may be implemented using the system 100 as illustrated in FIG. 1 and is described in detail in the description accompanying FIG. 1. Additionally or alternatively, the exemplary embodiment described herein may be implemented using system 400 as illustrated in FIG. 4 and is described in detail in the description accompanying FIG. 4.

Similar to the processes illustrated in FIGS. 2A, 2B and 2C, the process 300 illustrated in FIG. 3 includes compiling information regarding one or more facilities via step 302; registering at least one client by receiving registration information for the at least one client via step 304; storing the information for the one or more facilities and the at least one client to the at least one database via step 306; receiving a search request toilet including a geographical location of the facility or current location of the client for finding a facility via step 308.

The facility for use illustrated in FIG. 3 and described herein is a toilet, it may include any one or more of: a washroom, a restroom, a toilet, a mother's room, and a professionally maintained place for public usage such as a hotel room, a restaurant, a bathroom, a shower, a toilet and a trash bin or a combination thereof.

The method 300 includes registering a client via client device by receiving registration information for the client. The registration information for registering the client may include any one or more of: contact information of the client, mode of payment, payment account information, location of the client, relationship of the client requesting registration with the other registered clients.

Location of the client may be provided by the client themselves or may be tracked using commercially available location detection service on the client's communication device.

Mode of payment may include any one or more of: credit card, bank transfer, cash, a combination thereof etc. and payment account information may include any of credit card or debit card information, bank account information etc. that may be used to carry out the transaction. In an embodiment, this information may be optional.

The computer-implemented method further includes storing the compiled information regarding one or more facilities and the client. The information regarding one or more facilities and client may be stored in the same storage database or separate storage databases, which may be local to the server or may be remote.

Information regarding facilities available for public use, may be compiled and published as a static database. The static database may use existing commercially available maps showing businesses/other locations and update the maps with the facility information. The static database may be updated at regular intervals or based on number of new datapoints.

The facilities included in the database may be speculative and/or non-speculative. Speculative facilities, e.g., public toilets, may be complimentary facilities offered by the businesses for their customers, not just free facilities. The speculation may be based on one or more attributes including: type of business, e.g., a coffee shop, a restaurant or a gas station; name of the business, e.g., Starbucks™/Pizza Hut™, that is speculated to have a facility such as a toilet on their premises. Users/reviewers/entities may confirm the existence of such speculative toilets. Similarly, business owners may claim speculative toilets as one offered to their customers/non-customers by their business providing confirmation of existence of a facility, e.g., a toilet, offered by that business. Non-speculative facilities, e.g., public toilets, may be based on user input, where the users are aware of the existence of a facility from their experience and provide data to the app via user interface.

Once registered with the platform/application provider, the method allows the client to enter a search request to locate a facility for use. The search request may be entered via user interface on the client device. The search request to locate a facility may include providing any one or more of: location of the facility, location of the client, time of use etc. The method may allow the client to enter the criteria or filters to be used for the search via interactive user interface or to select the search criteria or filters to be used for the search from a drop-down list.

Additionally or alternatively, the minimum or primary criteria for matching the search request may be specified beforehand, e.g. at the time of registration or any time before the search is requested or at the time when the search is requested by the client. The matching facility may be chosen based on this predetermined criteria. The predetermined criteria may include any one or more of: distance between the facility and the client, location of the facility, location of the client, hours of operation of the facility, basic or mandatory service that a facility must offer to be included in the search result.

Upon receiving the search request, the method 300 uses an algorithm to identify facilities that match the search request received from the at least one client with at least one of the one or more facilities based on the criterion included in the search request and extracts raw data in a presentable format via step 310, for example, by sorting the available data by distance/location; and providing results of the matching to the at least one client via step 312, for example, by displaying “search results” to user along with more information regarding other parameters listed as facility information, e.g., type of business offering the facility, cleaning schedule of the facility, current cleaning status of the facility, status of the facility as claimed facility or unclaimed facility, certified facility, verified facility, maintenance information of the facility and type of facility such as free of charge, complementary or pay per use facility, reviews of the facility, date of review of the facility, rating of the facility, rating of the facility by the clients belonging to a network based on the relationship of the client requesting search with the other registered clients. The parameters listed as facility information herein are described in detail in the description accompanying FIGS. 1 and 2A.

The computer-implemented method 300 may further allow the user/client to refine the search results using user interface, wherein the user/client is allowed to enter the criteria of his choosing via step 314. For example, the user/client may enter criteria to choose facilities with a particular rating from his network, particular services etc. The process to create a network of client's choice and sorting the search results based on rating from a particular network is illustrated by FIG. 2C and described in detail in the description accompanying FIG. 2C. The computer-implemented method then re-processes the data and displays refined search results via step 316. The method 300 may further allow the user to choose a specific toilet/facility location and request additional information for that toilet/facility via step 318 and display detailed information for the specific toilet location as a result of the search. The user interface may also present an option to exit by seeking directions with map applications or new search or submit rating/review for specific toilet via step 320.

In an embodiment, the ratings, reviews and sorting mechanism used for the reviews and ratings discussed above are also applicable to other reviews and ratings such as quality of food, quality of service for restaurants, other services etc. Similarly, in an embodiment, the ratings and reviews based on reviews by clients/users from that user's/client's network created by the users/clients by selecting and adding other clients/users registered with the application/platform are also applicable to reviews and ratings for parameters such as quality of food, quality of service for restaurants, other services etc.

FIG. 4 shows an example system configuration 400 in one or more embodiments for locating facilities available for use may be implemented according to one or more embodiments described herein.

In an exemplary system configuration FIG. 4 similar to FIG. 1 shows a system for locating facilities 404₁ . . . 404ₙ available for use may be implemented. As depicted, configuration 400 also known as a platform for locating facilities available for use and includes, at least, a server 402, a storage database 406, an instance of a client application 410 hosted on a communication device 2 408 corresponding to a user 2 414, e.g., a client, a customer also referred to as a second user, and a user interface 2 412 along with an instance of a client application 418 hosted on a communication device 1 416 corresponding to a user 1 422, e.g., facility provider, a third party responsible for maintaining and certifying a facility etc. also referred to as a first user, and a user interface 1 420. Alternatively, the application may be hosted on the server 402.

Similar to the system illustrated in FIG. 1, the communication device 2/client device 2 408 and/or communication device1/client device 1 416 may refer to smartphone, tablet, PC, or other processor-driven computing device.

The facility for use may include any one or more of: a washroom, a restroom, a toilet, a mother's room, and a professionally maintained place for public usage such as a hotel room, a restaurant, a bathroom, a shower, a toilet, a trash bin, or a combination thereof.

The method and system may be provided as an application which may be a web-based application and/or a mobile application and allow users to enter facility information and to monitor facilities, e.g., for cleanliness and maintenance, and/or receive payments, feedback/instructions/issues for facility owners, facility provider, a third party/an entity responsible for maintaining and certifying a facility etc. (user 1) or to search/view facilities available for use using different criteria for facility users or clients (user2) using interactive user interface, e.g., user interface 1 420 for user 1 and/or user interface 2 412 for user 2. Although two communication devices are shown herein, more than two communication devices may be used.

Platform provider may refer to an entity providing an application for connecting a facility, for example, any one or more of facilities 404₁ . . . 404ₙ, with the client 414 and the platform may refer to the application 410 for providing information regarding a facility, for example, any one or more of facilities 404₁ . . . 404ₙ, to the client 414.

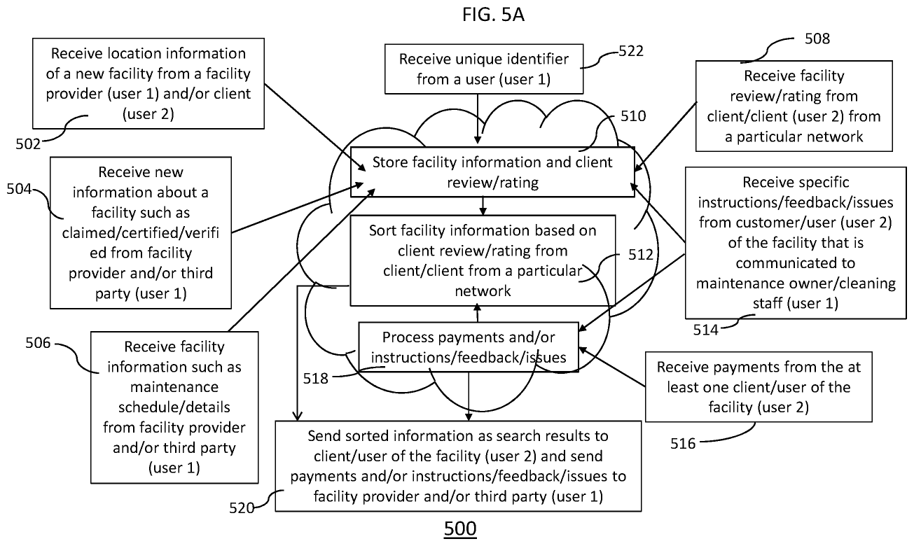

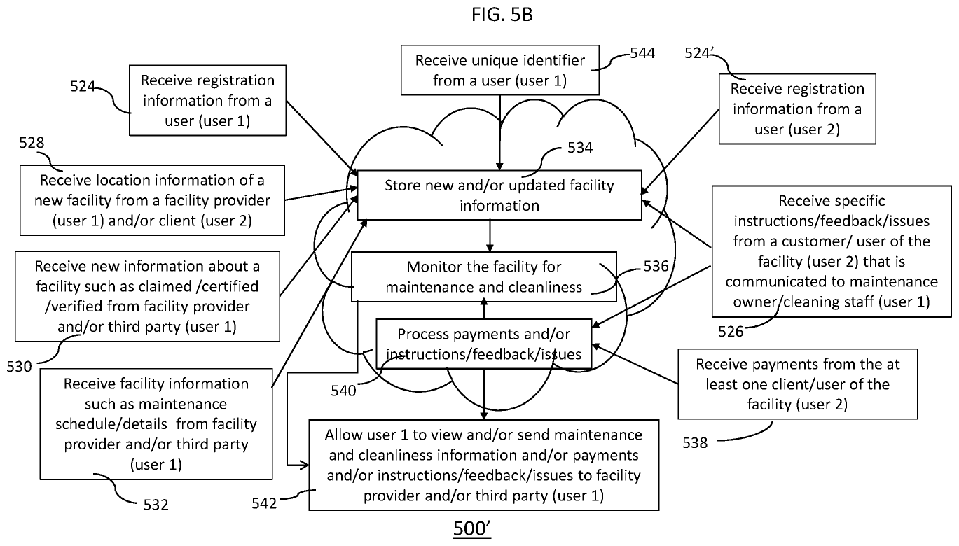

The communication device 1/client device 1 416 corresponding to a user 1 422, e.g., facility owner, facility provider, a third party/an entity responsible for maintaining and certifying a facility etc., and a user interface 1 420 may be used by user 1 to provide and/or update facility information as well as to provide registration information of user 1 to server 402 by a method illustrated in FIGS. 5A and B and described in detail in the description accompanying FIGS. 5A and B. Other system components illustrated in FIG. 4 and described herein are described in detail in the description accompanying FIG. 1.

In an example embodiment, a system 400 for monitoring a facility 404₁₋ₙ, includes a server 402 and a communication device 416 including a user interface 420, wherein the server further includes a processor in communication with a memory and at least one database 406. The server 402 is configured to: register at least one user 422 (user 1 or first user) by receiving registration information for the at least one user (user 1 or first user); register one or more facilities 404₁₋ₙ by receiving registration information for the one or more facilities 404ᵢ₋ₙ, wherein registration information for the one or more facilities 404ᵢ₋ₙ includes any one or more of: location of the facility, ownership of the facility, services available of the facility; and receive facility information from the at least one user including any one or more of: availability information for the facility, maintenance schedule of the facility, current maintenance status of the facility. Different embodiments of the method and system for monitoring a facility are illustrated in FIG. 5B and are described in detail in the description accompanying FIG. 5B.

FIG. 5A illustrates an example processing flow of operations 500 for updating information of the facilities available for use according to one or more embodiments described herein. The exemplary method for updating information of the facilities available for use described herein uses the system illustrated in FIG. 4 and described in detail in the description accompanying FIG. 4. In an exemplary embodiment, the method for updating information of the facilities available for use by the client described herein may use the system illustrated in FIG. 1 and described in detail in the description accompanying FIG. 1.

The method described herein allows/enables a user, e.g., a client (user 2), a facility provider and/or a third party (user 1) to enter location information of a new facility from a facility provider and/or client via user interface and includes receiving location information of a new facility via step 502. The facility for use may include any one or more of: a washroom, a restroom, a toilet, a mother's room, and a professionally maintained place for public usage such as a hotel room, a restaurant, or a bathroom, a shower, a toilet, a trash bin, or a combination thereof.

In an embodiment, the method and system described herein allows the facility owner, facility provider and/or a third party/an entity responsible for maintaining and certifying a facility to assign a unique identifier to a facility via step 522, wherein the unique identifier may include one or more letters, one or more digits or numbers or a combination of letters and numbers, which may then be stored as facility information in the storage database via step 510. For example, the facility described herein may be a stationary facility where the facility owner may own more than one facility at a particular location, or the facility may be a mobile facility such as a mobile or portable toilet. In such cases, identification based on location only may not sufficient and assigning a unique identifier to the facility may help identify a particular facility irrespective of other parameters.

Alternatively or additionally, the method described herein allows/enables a user, e.g., facility provider and/or third party to new information about a facility such as claimed/certified/verified facility and includes receiving new facility information such as claimed/certified/verified facility via step 504.

Alternatively or additionally, the method described herein allows/enables a user, e.g., facility provider and/or third party to enter facility information such as maintenance schedule/details and includes receiving facility information such as maintenance schedule/details via step 506.

Alternatively or additionally, the method described herein allows/enables a user, e.g., clients and/or third party to enter facility review/rating and includes receiving facility review/rating from client/client from a particular network from client/client from a particular network via step 508. Any number of chosen levels where the user level may be designated as level 0 to direct connections designated as network level 1, secondary connections designated as network level 2 and so on to network level N, similar to the network levels illustrated in FIG. 2C and described in detail in the description accompanying FIG. 2C.

In an embodiment, the method may include receiving specific instructions/feedback/issues from customer/user (user 2) that is communicated to maintenance owner/cleaning staff (user 1) via step 514. The feedback may include instructions or issues such as but not limited to reporting quality of facility, amenities missing from the facility, and/or any issues with the facility. For example, if something is not working in a hotel room, customers/users can report the issue to the facility provider and/or third party such as an entity responsible for maintaining the facility, maintenance staff etc.

The method further includes storing the newly updated facility information and client review/rating in a storage database via step 510. This stored information may then be sorted based on default criteria provided by the application or based on criteria specified by the client, e.g., location, last maintained, review/rating from a client, review/rating from a client from a particular network, etc., via step 512, which may then be provided to the client/customer (user 2) as search results as illustrated in FIGS. 1 and 4.

Rating of the facility may include information including rating in absolute number, e.g., on a scale of 1 to 5, or on a scale of 1-10 etc. and may be provided as overall rating, current year's rating, previous years' rating, current month's rating, previous months' rating, current week's rating, today's rating, any specific year/month/week/day rating etc. The client may be provided with a questionnaire to answer questions using user interface 412 on the client device 408, and the answers to the questionnaire may be used to calculate cumulative ratings in different formats discussed above. Different forms of ratings described herein, e.g., current year's rating, previous years' rating, current month's rating, previous months' rating, current week's rating, today's rating, any specific year/month/week/day rating etc., may be calculated and/or sorted based on the date of review.

In an embodiment, the information regarding a facility such as ownership of the facility, name of the facility may change over time which then may be reflected in reviews and ratings when sorted and provided as search results. For example, restaurants may go through ownership (management) change with same or different name and thus, ratings from the past do not hold much relevance to today's situation and hence the method and system described herein may sort the ratings and reviews of the restaurant that has undergone such changes based on name of the facility, change of ownership etc. as separate facilities rather than presenting them as a single facility.

In an embodiment, the ratings, reviews and sorting mechanism used for the reviews and ratings discussed above are also applicable to other reviews and ratings such as quality of food, quality of service for restaurants, other services etc. Similarly, in an embodiment, the ratings and reviews based on reviews by clients/users from that user's/client's network created by the users/clients by selecting and adding other clients/users registered with the application/platform are also applicable to reviews and ratings for parameters such as quality of food, quality of service for restaurants, other services etc.

Once sorted, this information may be provided to the client via user interface 2 as search results by working in concert with the methods 200 and 300 illustrated in FIGS. 2A-C and 3 and described in detail in the description accompanying FIGS. 2A-C and 3.

In an embodiment, the method and system allow receiving payments from the at least one client/user of the facility via step 514 and processing those payments and/or instructions/feedback/issues via step 518, wherein the payments and/or instructions/feedback/issues are provided to the facility provider and/or third party such as an entity responsible for maintaining the facility, maintenance staff etc. as requested by the client via step 520. The payments may include any one or more of: charge for the usage of the facility, tips or gratuity to the entity responsible for providing the facility and tips or gratuity to maintenance staff responsible for maintaining the facility.

FIG. 5B shows an example processing flow of operations 500′ for monitoring a facility according to one or more embodiments described herein. In an example embodiment, a computer-implemented method for monitoring a facility includes: registering at least one user (user 1 or first user) by receiving registration information for the at least one user via step 524; registering one or more facilities by receiving registration information for the one or more facilities via step 528, wherein registration information for the one or more facilities includes any one or more of: location of the facility, ownership of the facility, services available of the facility; and receiving facility information from the at least one user via steps 530 and/or 532. The facility information includes any one or more of: availability information for the facility, maintenance schedule of the facility, current maintenance status of the facility.

In an embodiment, the at least one first user (user 1) includes any one or more of: owner of the facility, an entity responsible for providing the facility, an entity responsible for maintaining the facility via step 524. In an embodiment, the method may include registering at least one user (user 2) by receiving registration information for the at least one user via step 524′.

In an embodiment, the method may include receiving specific instructions/feedback/issues from customer/user (user 2) that is communicated to maintenance owner/cleaning staff (user 1) via step 526. The feedback may include instructions or issues such as but not limited to reporting quality of facility, amenities missing from the facility, and/or any issues with the facility. For example, if something is not working in a hotel room, customers/users can report the issue to the facility provider and/or third party such as an entity responsible for maintaining the facility, maintenance staff etc.

The exemplary method for monitoring a facility described herein uses the system illustrated in FIG. 4 and described in detail in the description accompanying FIG. 4. The communication device 1/client device 1 408 illustrated in FIG. 4 may be used for registering a facility, for providing facility information and/or for monitoring a facility or may be used by an entity responsible for providing the facility, an entity responsible for maintaining the facility when owner of the facility, an entity responsible for providing the facility, an entity responsible for maintaining the facility are different entities and/or when two or more different entities are responsible for performing a job or a portion of the job. Although two communication devices are shown herein, more than two communication devices may be used.

The method described herein allows/enables a user, e.g., owner of the facility, an entity responsible for providing the facility, an entity responsible for maintaining the facility (user 1) to enter location information of a new facility via user interface and includes receiving location information of a new facility via step 528. The facility for use may include any one or more of: a washroom, a restroom, a toilet, a mother's room, a professionally maintained place for public usage such as a hotel room, a restaurant, a bathroom, a shower, a toilet, a trash bin, or a combination thereof.

In an embodiment, the method and system described herein allows the facility owner, facility provider and/or a third party/an entity responsible for maintaining and certifying a facility (user 1) to assign a unique identifier to a facility via step 544, wherein the unique identifier may include one or more letters, one or more digits or numbers or a combination of letters and numbers, which may then be stored as facility information in the storage database via step 534. For example, the facility described herein may be a stationary facility where the facility owner may own more than one facility at a particular location, or the facility may be a mobile facility such as a mobile or portable toilet. In such cases, identification based on location only may not sufficient and assigning a unique identifier to the facility may help identify a particular facility irrespective of other parameters.

Alternatively or additionally, the method described herein allows/enables a user, e.g., owner of the facility, an entity responsible for providing the facility, an entity responsible for maintaining the facility to enter new or updated information about a facility such as claimed/certified/verified facility and includes receiving new facility information such as claimed/certified/verified facility via step 530. In case of verified facility, existence of the facility may be verified either by the facility provider as a claimed facility, by a user of the facility as an existing facility or by a third party as an existing facility. In case of certified facility, a facility may be certified by an entity, for example, the platform/application provider and/or a third-party responsible for providing such certification, regarding cleanliness of the facility, maintenance schedule, availability of the services at the facility, etc.

Alternatively or additionally, the method described herein allows/enables a user, e.g., owner of the facility, an entity responsible for providing the facility, an entity responsible for maintaining the facility to enter facility information such as maintenance schedule/details and includes receiving facility information such as maintenance schedule/details via step 532. Facility providers or third parties responsible for maintenance and/or certification of the facility, may view maintenance information of the facility, e.g., “maintained” toilets/hotel rooms which may be toilets/hotel rooms maintained by “third party” that ensures cleanliness, amenities etc. for a toilet/hotel room. Maintenance information of the facility may include information such as, for example, the information logged in may include last cleaned, soap refilled, toilet paper refilled etc. for toilets, and may include other information such as change of bedding etc. for hotel rooms.

The method further includes storing the new and newly updated facility information in a storage database via step 534. This stored information may then be used to monitor the facility for maintenance and cleanliness via step 536.

In an embodiment, the method and system may allow the facility provider and/or third party such as an entity responsible for maintaining the facility, maintenance staff etc. (user 1) to monitor the facility, e.g., for cleanliness and maintenance, etc. via step 542. This information may be sent to the user 1 or user 1 may be allowed to view the information by logging into the application.

In an embodiment, the method and system may allow receiving payments from the at least one client/user of the facility (user 2) via step 538 and processing those payments and/or instructions/feedback/issues via step 540, wherein the payments and/or instructions/feedback/issues are provided to the facility provider and/or third party such as an entity responsible for maintaining the facility, maintenance staff etc. (user 1) as requested by the client via step 542. The payments may include any one or more of: charge for the usage of the facility, tips or gratuity to the entity responsible for providing the facility and tips or gratuity to maintenance staff responsible for maintaining the facility.

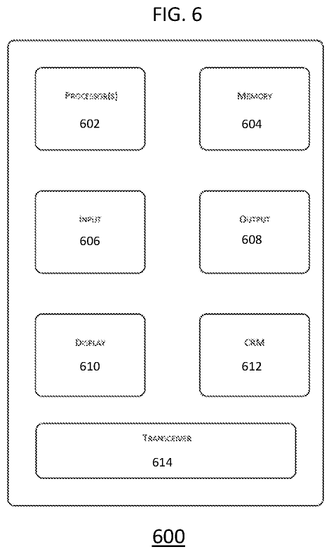

FIG. 6 shows a block diagram illustrating an example computing device for implementing a method for locating facilities available for use and for implementing a method for monitoring a facility.

More particularly, FIG. 6 shows an illustrative computing embodiment, in which any of the processes and sub-processes of locating facilities available for use may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 600 may typically include, at least, one or more processors 602, a system memory 606, one or more input components 606, one or more output components 608, a display component 610, a computer-readable medium 612, and a transceiver 614.

Processor 602 may refer to, e.g., a microprocessor, a microcontroller, a digital signal processor, or any combination thereof.

Memory 604 may refer to, e.g., a volatile memory, non-volatile memory, or any combination thereof. Memory 604 may store, therein, an operating system, an application, and/or program data. That is, memory 604 may store executable instructions to implement any of the functions or operations described above and, therefore, memory 604 may be regarded as a computer-readable medium.

Input component 606 may refer to a built-in or communicatively coupled keyboard, touch screen, or telecommunication device. Alternatively, input component 606 may include a microphone that is configured, in cooperation with a voice-recognition program that may be stored in memory 604, to receive voice commands from a user of computing device 600. Further, input component 606, if not built-in to computing device 600, may be communicatively coupled thereto via short-range communication protocols including, but not limited to, radio frequency or Bluetooth.

Output component 608 may refer to a component or module, built-in or removable from computing device 600 that is configured to output commands and data to an external device.

Display component 610 may refer to, e.g., a solid state display that may have touch input capabilities. That is, display component 610 may include capabilities that may be shared with or replace those of input component 606.

Computer-readable medium 612 may refer to a separable machine readable medium that is configured to store one or more programs that embody any of the functions or operations described above. That is, computer-readable medium 612, which may be received into or otherwise connected to a drive component of computing device 600, may store executable instructions to implement any of the functions or operations described above. These instructions may be complimentary or otherwise independent of those stored by memory 604.

Transceiver 614 may refer to a network communication link for computing device 600, configured as a wired network or direct-wired connection. Alternatively, transceiver 614 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system for monitoring a facility, comprising a server and a communication device including a user interface,
wherein the server further comprises a processor in communication with a memory and at least one database, and
wherein the server is configured to:
register at least one first user by receiving registration information for the at least one first user;
register one or more facilities by receiving registration information for the one or more facilities, wherein registration information for the one or more facilities comprises any one or more of: location of the facility, ownership of the facility, services available of the facility; and
receive facility information from the at least one first user including any one or more of: availability information for the facility, maintenance schedule of the facility, current maintenance status of the facility.

2. The system of claim 1, wherein the at least one first user comprises any one or more of: owner of the facility, an entity responsible for providing the facility, an entity responsible for maintaining the facility.

3. The system of claim 2, wherein the server is further configured to allow the at least one first user to assign a unique identifier to the facility, wherein the unique identifier may include one or more letters, one or more digits or numbers or a combination of letters and numbers.

4. The system of claim 1, wherein the facility comprises any of: a washroom, a restroom, a toilet, a mother's room, a professionally maintained place for public usage or a combination thereof.

5. The system of claim 1, wherein the server is further configured to receive feedback from a second user;
process feedback from the second user; and
send feedback from the second user to the first user.

6. The system of claim 2, wherein the server is further configured to receive one or more payments from the second user; process the one or more payments from the second user; and send the one or more payments to the first user, wherein the one or more payments include any one or more of charge for the usage of the facility, tips or gratuity to the entity responsible for providing the facility and tips or gratuity to maintenance staff responsible for maintaining the facility.

7. The system of claim 1, wherein the communication device comprises any of a smartphone, tablet, PC, or other processor-driven computing device.

8. A computer-implemented method comprising:
registering at least one first user by receiving registration information for the at least one first user;
registering one or more facilities by receiving registration information for the one or more facilities, wherein registration information for the one or more facilities comprises any one or more of: location of the facility, ownership of the facility, services available of the facility; and
receiving facility information from the at least one first user including any one or more of: availability information for the facility, maintenance schedule of the facility, current maintenance status of the facility.

9. The computer-implemented method of claim 8, wherein the at least one first user comprises any one or more of: owner of the facility, an entity responsible for providing the facility, an entity responsible for maintaining the facility.

10. The computer-implemented method of claim 9, wherein the method further comprises assigning a unique identifier to the facility by the at least one first user, wherein the unique identifier may include one or more letters, one or more digits or numbers or a combination of letters and numbers.

11. The computer-implemented method of claim 8, wherein the facility comprises any of: a washroom, a restroom, a toilet, a mother's room, a professionally maintained place for public usage or a combination thereof.

12. The computer-implemented method of claim 8, further comprising receiving feedback from a second user;
processing feedback from the second user; and
sending feedback from the second user to the first user.

13. The computer-implemented method of claim 9 further comprising receiving one or more payments from the second user; processing the one or more payments from the second user; and sending the one or more payments to the first user, wherein the one or more payments include any one or more of charge for the usage of the facility, tips or gratuity to the entity responsible for providing the facility and tips or gratuity to maintenance staff responsible for maintaining the facility.

14. A non-transitory computer-readable medium storing instructions that, when executed, cause one or more processors corresponding to a system having a server and a communication device, to perform operations comprising:
registering at least one first user by receiving registration information for the at least one first user;
registering one or more facilities by receiving registration information for the one or more facilities, wherein registration information for the one or more facilities comprises any one or more of: location of the facility, ownership of the facility, services available of the facility; and
receiving facility information from the at least one first user including any one or more of: availability information for the facility, maintenance schedule of the facility, current maintenance status of the facility.

15. The non-transitory computer-readable medium of claim 14, wherein the at least one user comprises any one or more of: owner of the facility, an entity responsible for providing the facility, an entity responsible for maintaining the facility.

16. The non-transitory computer-readable medium of claim 15, wherein the instructions further comprise: allowing the at least one first user to assign a unique identifier to the facility, wherein the unique identifier may include one or more letters, one or more digits or a combination of letters and numbers.

17. The non-transitory computer-readable medium of claim 14, wherein the facility comprises any of: a washroom, a restroom, a toilet, a mother's room, a professionally maintained place for public usage or a combination thereof.

18. The non-transitory computer-readable medium of claim 14, wherein the instructions further comprise: receiving feedback from a second user; processing feedback from the second user; and sending feedback from the second user to the first user.

19. The non-transitory computer-readable medium of claim 15, further comprising instructions to receive one or more payments from the second user; process the one or more payments from the second user; and send the one or more payments to the first user, wherein the one or more payments include any one or more of charge for the usage of the facility, tips or gratuity to the entity responsible for providing the facility and tips or gratuity to maintenance staff responsible for maintaining the facility.
